(19) United States
(12) Patent Application Publication
(10) Pub. No.: US 2008/0198711 A1
(43) Pub. Date: Aug. 21, 2008

(54) Power Calibration Method For Visible Label Recording

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,161

(22) PCT Filed: Jun. 13, 2006
(86) PCT No.: PCT/IB2006/051873

§ 371 Date: Dec. 11, 2007

(30) Foreign Application Priority Data
Jun. 14, 2005 (EP) 05105187.8

(51) Int. Cl. G11B 5/00

(52) U.S. Cl. 369/47.53

(57) ABSTRACT

In summary, the present invention provides an efficient method of calibrating power for writing visible labels on an optical record medium. If the writing power is too low, the label will have a low contrast, while the image might even disappear after some time. If the writing power is too high, ablation might occur which means that the layer comes off forming blisters or flakes. The present invention solves this problem by providing a calibration method wherein a test pattern is recorded on an optical record medium with different power of the beam of light, the patterns recorded are read back and a reference power value is obtained from the patterns read back using a predetermined criterion. This reference power value obtained is used to calibrate the power needed for writing visible labels on the label side of an optical record medium.

The present invention relates to a method of calibrating power for writing visible labels on an optical record medium, a method of recording visible labels on an optical record medium and to an apparatus for writing visible labels on an optical record medium.

Hewlett Packard (HP) has disclosed LightScribe Direct Disc Labeling technology that combines CD or DVD drives of a computer with specially coated discs known as LightScribe discs. A LightScribe disc includes a data side and a label side. The data side is where the data is written to, whereas the label side is one that is coated with a special material on which labels can be recorded. HP's LightScribe technology allows creation of labels for CD's and DVD's. With HP's LightScribe technology, the disc is the label. LightScribe technology creates a gray-scale image similar to a black and white photograph. One can burn his data and then flip the disc and burn his own unique label. For example, if you have created a music CD of your favourite songs and you want to make a label that contains the following: a) song titles b) artists names c) personal information. Then, first you have to burn your tracks onto the data side of the disc. Then you have to flip the disc over to the label side and put it back in the drive. You can burn your label by using the LightScribe enabled label making software where you can import pictures, text and other artwork. When you are satisfied, you can click print and the selected label is printed on the label side of the disc. A LightScribe enabled CD/DVD disc drive contains a laser that is used to energise the coating on the label side of the disc. The light from the laser causes a chemical change in the dye coating that shows up a visible point on the disc. With laser precision, LightScribe drive delivers closely controlled light energy to multiple points on the disc as it spins in the drive. This results in reproduction of the artwork, text or photos that has been selected. LightScribe Direct Disc Labeling technology is now available in PC's, external USB optical DVD writers. Additional information on HP's LightScribe technology is available at http://www.LightScribe.com. It is important to note that HP's LightScribe Direct Disc Labeling technology is one example of creating visible labels on a optical disc. Similar labeling systems that allow visible labels to be created on a optical disc are available. Information on one such labeling system from Yamaha is available at http://www.yamahumultimedia.com.

EP0475558 discloses a calibration procedure for calibrating the power of the beam of light for writing on the data side of a optical record medium. This calibration method comprises the operation of controlling the recording intensity of the beam of light and using the intensity of beam of light corresponding to the read back signal having the largest amplitude to record data. This calibration procedure is not suitable for label writing because the signals reflected from a written area do not necessarily differ from the signals from a blank area. This prohibits contrast evaluation using conventional readout. Further, after this calibration procedure is performed, a pattern written in the test area of the label side could be visible, which would degrade the users label.

The object of the invention is to provide a method and apparatus for calibration of light power for recording visible labels on an optical record medium that is coated with a special material that allow labels to be recorded.

According to the object of the invention, a method of calibration of light power used for recording labels on an optical record medium comprises the steps of

recording patterns on an optical record medium using a beam of light, the patterns being recorded with different power of the beam of light,

reading back the patterns recorded on the optical record medium,

obtaining a reference power value from the patterns read back using a predetermined criterion,

using the reference power value obtained to calibrate the power for writing the visible label on the label side of the optical record medium.

In the first and second embodiments of the invention, the optical record medium on which the patterns are recorded is a phase change optical record medium. This has the advantage that the patterns can be overwritten by using the phase changes in the signal recording layer of the optical record medium.

In a first embodiment of the method according to the invention, the predetermined criterion for obtaining the reference power value is based on modulation depth of the patterns recorded. Further, the reference power value obtained is based on a certain change in modulation depth of the patterns recorded relative to the power of the beam of light used for recording the patterns. The reason that using the modulation depth as a criterion is particularly advantageous for the method according to the invention, is that the modulation depth on a phase change disc is roughly proportional to the width of the written marks, while also the contrast on a LightScribe disc is proportional to that width. So, therefore a direct relation between the modulation depth on a phase change disc and the contrast on a LightScribe disc exists, and is utilized in the invention.

In a second embodiment of the method according to the invention, the predetermined criterion for obtaining the reference power value is based on evaluating the visibility of the patterns recorded. The visibility is evaluated based on a threshold value, the threshold value being the power at which a particular pattern recorded becomes visible in the read out signal.

This has the advantage of obtaining an assessment of read back signal with respect to write power. From this, the key information that is obtained is the threshold writing power, which will be a measure of optical record medium writing sensitivity and possible estimates of write power margin, the power ranges over which acceptable writing can be performed.

In a third embodiment of the method according to the invention, the predetermined criterion for obtaining the reference power value is based on manual visual inspection of the pattern written. This manual inspection takes advantage of human judgment in obtaining labels that appear close to human vision system. Further, the optical record medium on which patterns are written is a medium that is coated with a special material on which labels can be recorded by the same recorder that records data on the data side of the optical record medium.

In a fourth embodiment of the method according to the invention, the predetermined criterion for obtaining the reference power value is based on evaluating visibility of gray level of the pattern to be compared with a target gray level on a sheet of paper. This comparison of gray levels has the advantage of capturing users perception of gray level resulting in obtaining labels close to what the user needs. Further, the optical record medium on which patterns are written is a medium that is coated with a special material on which labels can be recorded by the same recorder that records data on the data side of the optical record medium.

In a fifth embodiment of the method according to the invention, the reference power value obtained is stored in an Electrically Erasable Programmable Read Only Memory (EEPROM) of the apparatus for writing visible labels on the optical record medium. Since EEPROM is a non volatile memory, it can retain data even when it is not receiving power and hence the reference power value stored can be reused for subsequent labelling operation.

In a sixth embodiment of the method according to the invention, the reference power value obtained is stored in a database which can be accessed over a network. Storing in a database has the advantage that the reference power value obtained can be made use of by a number of users or by the same user whenever user needs to record label on the optical record medium.

In a seventh embodiment of the method according to the invention, the reference power value obtained is stored in a power meter. This has the advantage of carrying out subsequent calibrations by using the power meter rather than using a optical record medium.

In an eighth embodiment, a method of recording visible labels on an optical record medium using the apparatus according to the invention is illustrated.

In a first embodiment of the apparatus for writing visible labels on an optical record medium, the apparatus comprises

a light source for recording patterns on the optical record medium,

a read head for reading back the patterns recorded,

an analyser for analysing the patterns read back using a predetermined criterion,

means for obtaining a reference power value,

storage means for storing the reference power value obtained,

a power controller for controlling the intensity of the light source using the reference power value, when recording the visible label on the optical record medium.

In a second embodiment of the apparatus according to the invention, the apparatus comprises an EEPROM for storing the reference power value.

In a third embodiment of the apparatus according to the invention, the apparatus comprises a database for storing the reference power value that can be accessed over a network.

In a fourth embodiment of the apparatus according to the invention, the apparatus comprises a power meter for storing the reference power value.

These and other aspects of the invention will be apparent from the embodiments described in the following description and with reference to the accompanying drawings in which

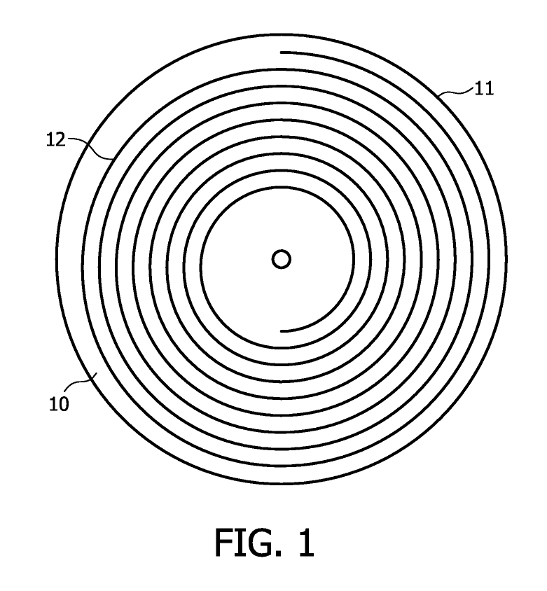

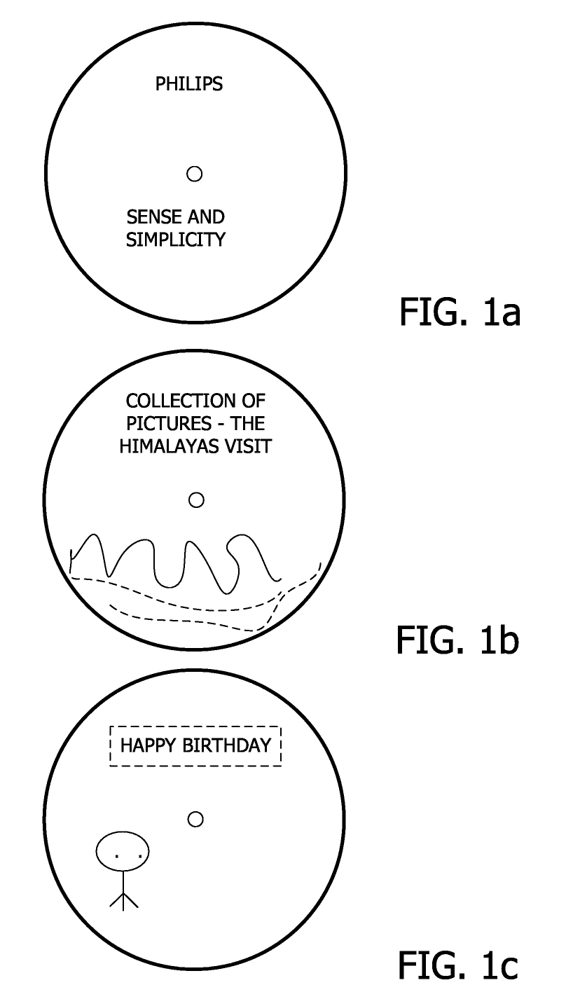

FIG. 1 shows an optical record medium on which visible labels can be written using a beam of light,

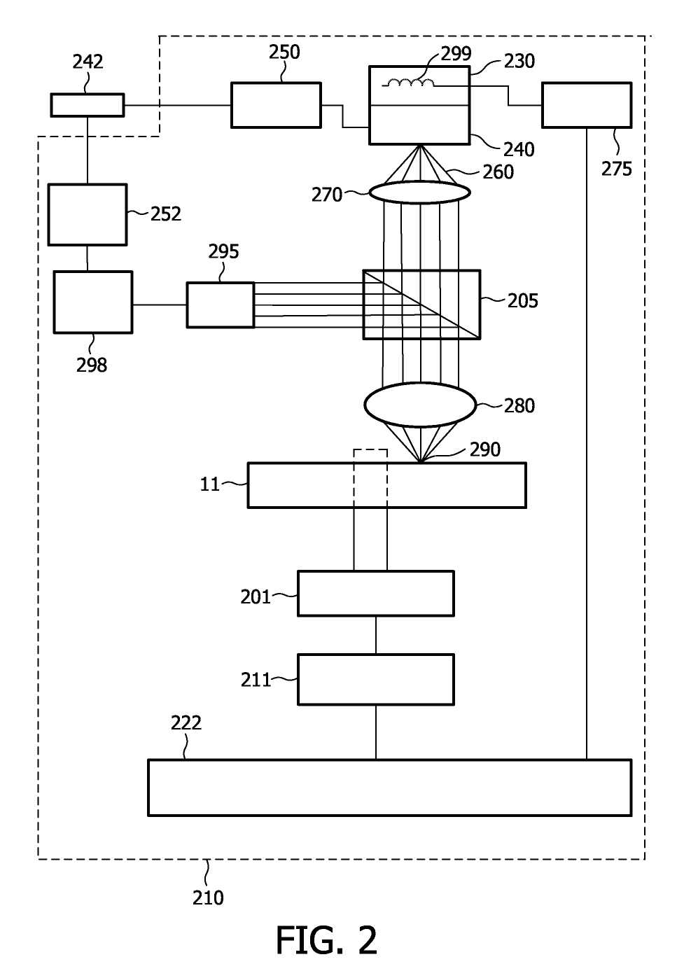

FIG. 2 shows a first embodiment of the apparatus that is used for recording visible labels on an optical record medium according to the invention,

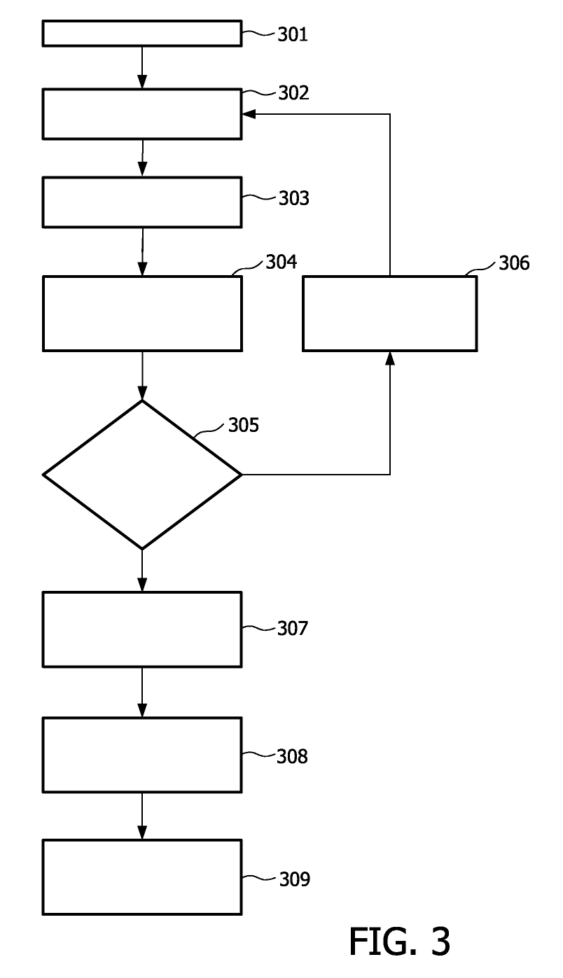

FIG. 3 shows a simplified flowchart showing the power calibration method to write visible labels using a beam of light according to the invention,

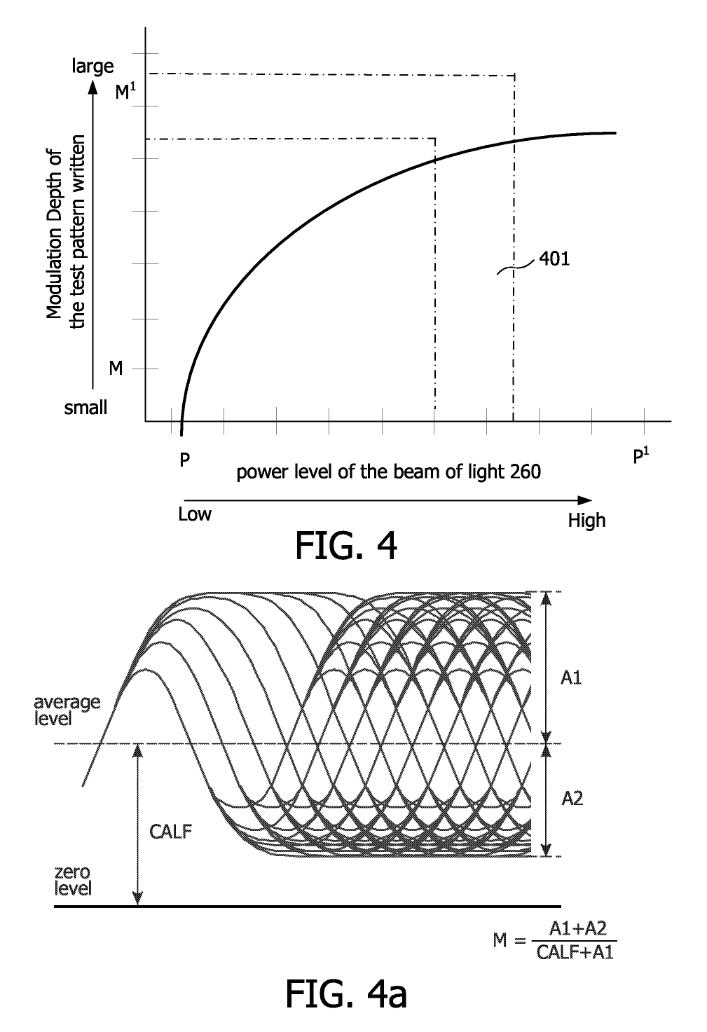

FIG. 4 and FIG. 4a show a first embodiment of the method according to the invention, wherein the predetermined criterion for obtaining the reference power value is based on modulation depth of the patterns recorded,

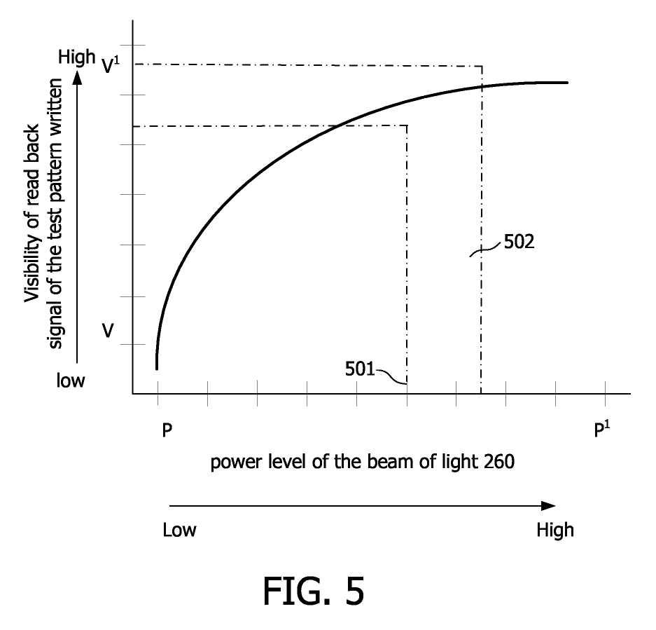

FIG. 5 shows a second embodiment of the method according to the invention, wherein the predetermined criterion for obtaining the reference power value is based on evaluating visibility of the read back signal of the pattern recorded,

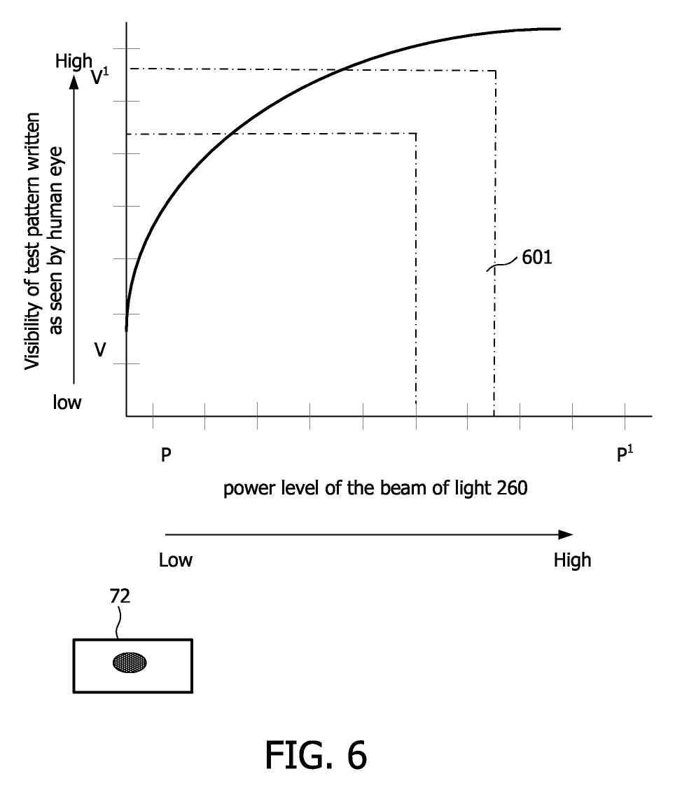

FIG. 6 shows a third embodiment of the method according to the invention, wherein the predetermined criterion for obtaining the reference power value is based on manual visual inspection of the pattern recorded,

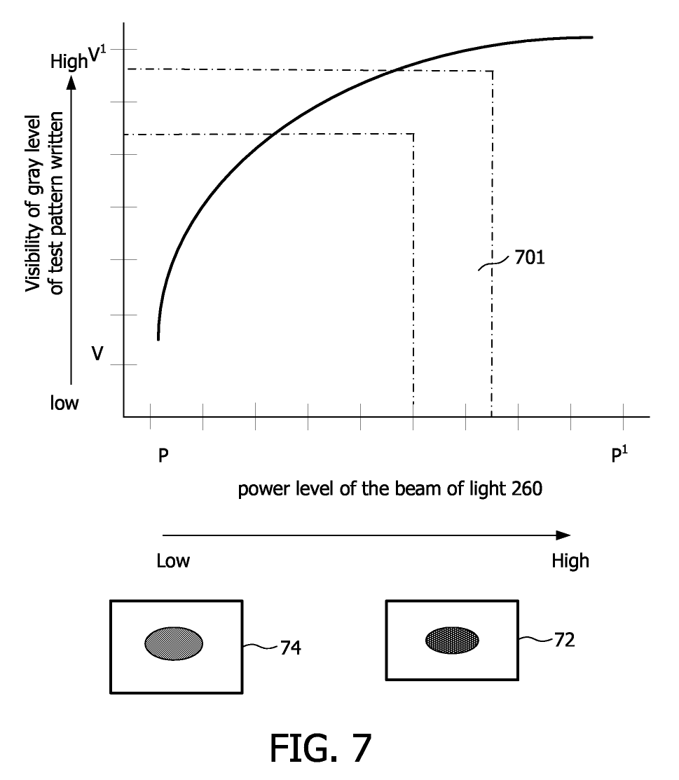

FIG. 7 shows a fourth embodiment of the method according to the invention, wherein the predetermined criterion for obtaining the reference power value is based on evaluating visibility of gray level of the pattern to be compared with a target gray level on a sheet of paper,

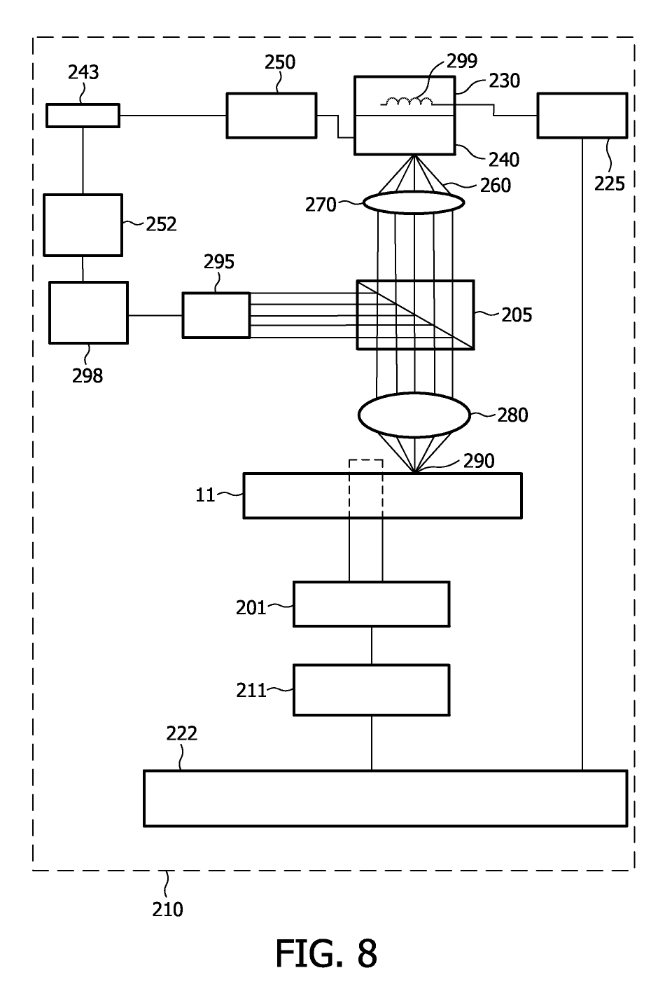

FIG. 8 shows a fifth embodiment of the method according to the invention and a second embodiment of the apparatus, wherein the reference power value obtained is stored in an Electrically Erasable Programmable Read Only Memory of the apparatus for writing visible labels on the optical record medium,

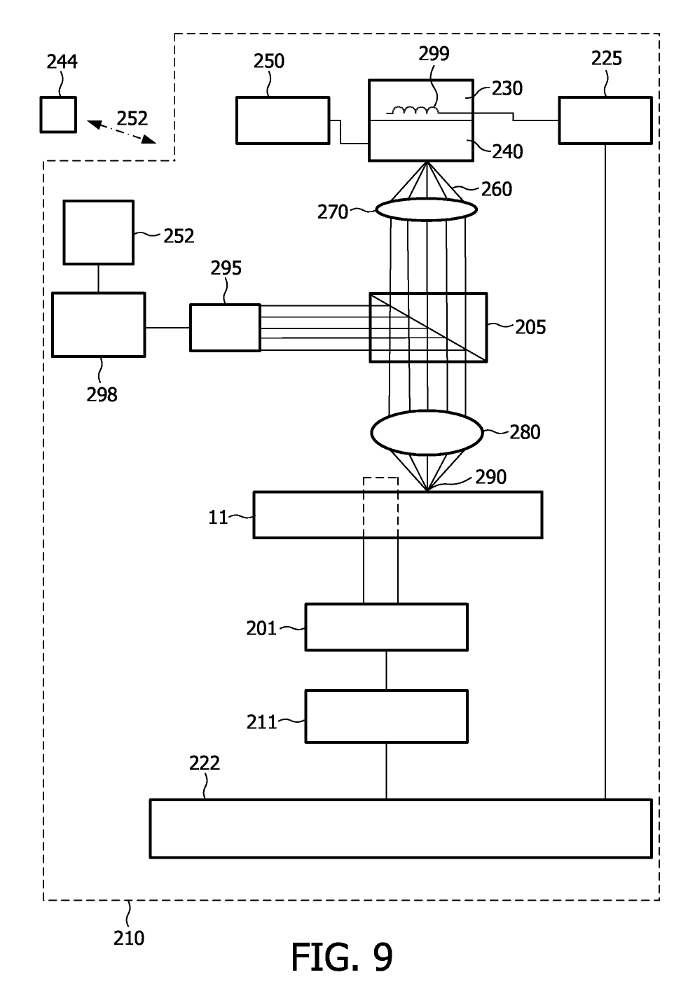

FIG. 9 shows a sixth embodiment of the method according to the invention and a third embodiment of the apparatus, wherein the reference power value obtained is stored in a database which can be accessed over a network,

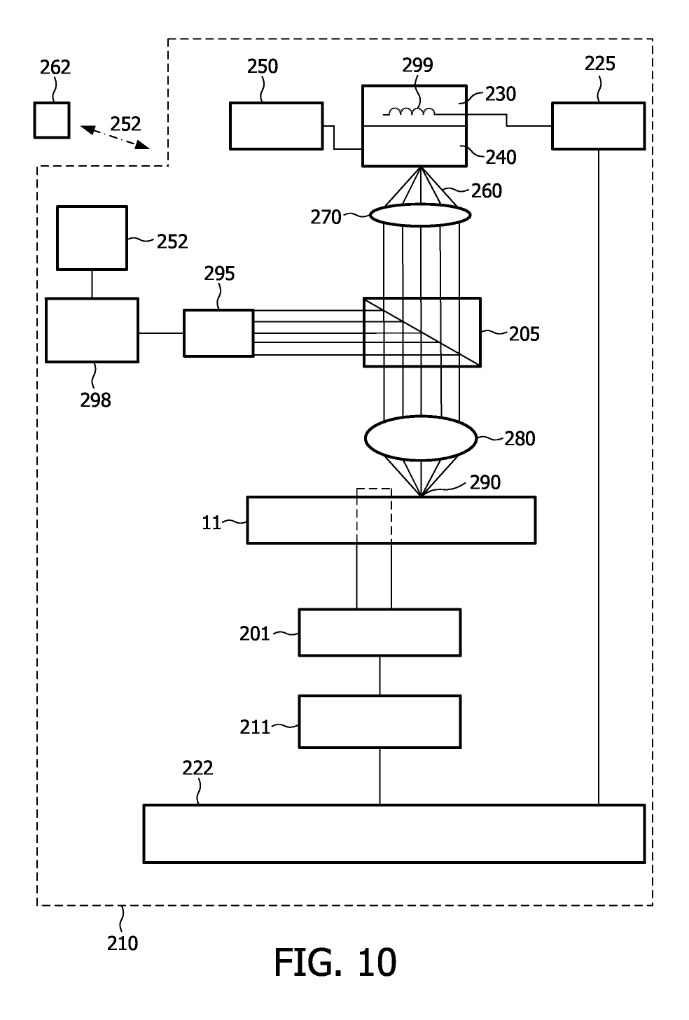

FIG. 10 shows a seventh embodiment of the method according to the invention and a fourth embodiment of the apparatus, wherein the reference power value obtained is stored in a power meter.

FIG. 1 shows a disc shaped optical record medium 11 having a data side and a label side. The data side 10 has tracks 12 wherein recordable marks representing information is arranged. The tracks can be concentric or parallel. The flip side of the optical record medium is the label side 13. The label side is coated with a special material that allows labels to be written using a beam of light. Examples of such optical record medium are CD-R, CD-RW and writable versions of DVD such as DVD+RW. It should be noted that any type of optical record medium that is coated with special material that allows labels to be written using a beam of light could also be used. One such example is a card information carrier. For illustration purposes, a disc shaped optical record medium has been used, but other shapes of optical record medium can also be used. FIG. 1a, FIG. 1b and FIG. 1c show some examples of visible labels that can be created on the label side of an optical record medium. FIG. 1a shows the label side 13 of the optical record medium 11 that has been recorded with a company logo as PHILIPS. FIG. 1b shows a visible label that is recorded with both text and image. It has the text as “Collection of pictures—The Himalayas visit” and the scenic picture of the Himalayas showing mountains, valleys and river streams. FIG. 1c shows a visible label that has been recorded on the label side of the optical record medium with text message as “Happy Birthday” along with the picture of Peter.

FIG. 2 shows a first embodiment of the apparatus 210 used for recording visible labels on an optical record medium 11 according to the invention. The apparatus 210 comprises a spindle motor 201 which serves as a revolving unit for revolving an optical record medium 11. A motor driver 211 and a servo-processing unit 222 control the spindle motor 201 so as to provide a constant linear velocity or constant angular velocity. The servo-processing unit 222 controls the rotation of the spindle motor 201. A read head 230 is used for reading the tracks 12 on the optical record medium 11. The read head 230 has a light source 240. This light source 240 irradiates the optical record medium 11 with a light beam 260 for recording data. This light source 240 may be for example an infrared laser diode having a wavelength of 780 nm and an optical power of 3 mW. The light beam power controller 250 adjusts the power intensity of the beam of light 260 originating from the light source 240. In order to control this power intensity of beam of light 260, the light beam power controller 250 uses the reference power value stored in the storage device 242 and changes the value of the current supplied to the light source 240. The light beam 260 passes through an optical system comprising optical elements such as collimator lens 270 for collimating the light beam 260, and an objective lens 280 for focusing the light beam 260 to a light spot 290 on the track of the optical record medium 11. The read head 230 further comprises an actuator to focus the light beam 260 on the optical record medium 11, and a tracking actuator 299 and a positioning means 275 for coarse and fine positioning of the light spot 290 in the radial direction of the center of the track. By varying the position of the objective lens 280, the track can be followed by the light beam 260. After having reflected by the optical record medium 11, the light beam 260 is detected by a detector 295 of a known type for example a quadrant detector and generates detected signals such as a read signal. A beam splitting cube 205, a polarizing beam splitting cube or a pellicle can be made use of for this purpose. The detection means 298 converts the detected beam of light from the detector 295 and outputs a read back signal. An analyzer 252 analyses the read back signal and obtains a reference power value. This reference power value is stored in the storage device 242.

In the first and second embodiments of the invention, the optical record medium on which the test patterns are recorded is a phase change optical record medium. A recording layer having a phase reversible material changeable between a crystalline phase and an amorphous phase is generally known as a phase change layer. A recording operation of optical signals is performed in such a manner that the recording material in this layer is changed in phase reversibly between an amorphous phase and a crystalline phase by changing the irradiation conditions of the light beam thereby recording signals in the phase change layer. The playback operation of the recorded signals is performed by detecting differences in optical properties between the amorphous and crystalline phases of the phase change layer thereby producing the recorded signals. Such a phase change layer allows information to be recorded and erased by modulating power of the light beam between a write power level and an erase power level.

FIG. 3 shows a simplified flowchart showing the power calibration method to write visible labels using the beam of light 260 on the optical record medium 11 according to the invention. The calibration method comprises selecting a test pattern in step 301. This test pattern selected in step 301 is written on the optical recording medium 11 with a power level P of the beam of light 260 in step 302. In next step 303, the test pattern written is read back using a read head 230 as illustrated in FIG. 2. In step 304, the read back signal is evaluated using predetermined criteria. The various criterions that can be used and the advantages of each one of them is described in the embodiments. In step 305, a check is carried out to verify whether the predetermined criterion is satisfied. In case the predetermined criterion is not satisfactory, in step 306 the power level of the beam of light 260 is changed by an amount δp by the light beam control section 250 and the test pattern is again written, read back and the read back signal is evaluated. The steps 302, 303, 304, 305 is iterated until the predetermined criterion is satisfied. In step 307, a reference power value is obtained which is the power level at which the predetermined criterion is satisfied. In step 308 the reference power value obtained is stored in the storage device 242. The various storage mechanisms that can be used and the advantages of using each one of them is described in the embodiments. In step 309 the reference power value stored in the storage device 242 is used to calibrate the power of the light beam 260 needed to record labels on the optical record medium 11.

In a first embodiment of the method according to the invention, the predetermined criterion used for obtaining the reference power value is based on modulation depth of the test patterns recorded. FIG. 4 represents the relationship of modulation depth of the recorded test pattern with respect to power level of the beam of light 260 used for recording the test pattern on the data side of the optical record medium 11. The light power level of the beam of light 260 increases from point P to P¹ along the horizontal axis which results in recording the selected test pattern at various power levels P, . . . P¹ of the beam of light 260. The variation of this power level could even be decreasing from a high power value P¹ to P of the beam of light 260 for recording the test pattern. The vertical axis gives an indication of the modulation depth of the pattern written at a particular power level of the beam of light 260. The modulation depth M of the pattern written is calculated as shown in FIG. 4a. The test pattern written is read back and the read back signal is analyzed by the analyzer 252. The analyzer 252 will analyze the modulation depth of the pattern written, the power of the beam of light 260 used for writing the pattern and the visibility level of the pattern written. The modulation depth is compared with the visibility level of the read back signal and the write power level corresponding to the modulation depth. The range 401 of modulation depth and the corresponding write power that meets the visibility level of the read back signal is determined which gives the reference power value. Using the power of the beam of light 260 corresponding to the range 401 where the modulation depth and the corresponding power of the beam of light 260 result in strong visibility of the read back signal is important for ensuring precise recording of the pattern on the optical record medium 11. The power level of the beam of light 260 at which the modulation depth of the written pattern results in good visibility level of the read back signal determines this reference power value. When a pattern is recorded using this reference power value of the beam of light 260, it results in good visible labels.

In a second embodiment of the method according to the invention, the predetermined criterion for obtaining the reference power value is based on evaluating visibility of the read back signal of the test pattern written on the data side of the optical record medium 11. FIG. 5 represents the visibility relationship of read back signal of the test pattern written with respect to power level of the beam of light 260 used for recording the test pattern. The light power level of the beam of light 260 increases from point P to P¹ along the horizontal axis which results in recording the selected test pattern at various power levels P, . . . P¹ of the beam of light 260. The variation of this power level could even be decreasing from a high power value P¹ to P of the beam of light 260 for recording the test pattern. The vertical axis gives an indication of the visibility strength V, . . . V¹ of the test pattern written in the read back signal at a particular power level of the beam of light 260. The analyzer 252 analyzes the read back signal for assessing the visibility. The power range 502 of the beam of light 260 at which the visibility of the read back signal of the pattern written is greater than a threshold value 501, the threshold value 501 being the power level at which the particular test pattern written becomes visible in the read out signal determines the reference power value. Using the power of the beam of light 260 corresponding to the read back signal that results in good visibility of read back signal is important for ensuring precise recording of the pattern on the optical record medium 11. When a pattern is recorded using this reference power value of the beam of light 260, it results in good visibility in the read back signal and the labels recorded will be of good quality. The threshold criterion is a very precise criterion as the associated reference power can be determined with high accuracy because it is only depending on the composition of the phase change layer, and not on the spot form.

In the third and fourth embodiments of the invention, the optical record medium on which test patterns are written is a LightScribe disc. The LightScribe disc is coated with a special material on which labels can be recorded on the label side. Further, any disc that is coated with a special material that allow labels to be recorded can also be used. It should be noted that it is possible to use a LightScribe disc which is of a phase change type that has a data side on which patterns can be written using phase changes.

In a third embodiment of the method according to the invention, the predetermined criterion for obtaining the reference power value is based on manual inspection of the test pattern written. FIG. 6 represents the relationship of the visibility of the test pattern written on label side of the LightScribe disc as seen by a human eye with respect to the power level of the beam of light 260 used for recording the test pattern. The light power level of the beam of light 260 increases from point P to P¹ along the horizontal axis which results in recording the selected test pattern at various power levels P, . . . P¹ of the beam of light 260. The variation of this power level could even be decreasing from a high power value P¹ to P of the beam of light 260 for recording the test pattern. The vertical axis gives an indication of the visibility level V, . . . V¹ of the test pattern written as seen by a human eye. The test pattern written with a power level P is read back and displayed on a display unit 72. The displayed test pattern is evaluated for visibility by a human eye. Using the power range 601 of the beam of light 260 corresponding to the range where the visibility of the test pattern displayed is good and acceptable by the human eye is important for ensuring precise recording of the pattern on the optical record medium 11. The power level of the beam of light 260 at which the test pattern written is visible and acceptable to the human eye as seen on the display unit 72 will determine the reference power value. This reference power value provides an recording light power level of the beam of light 260 that ensures precise recording of the pattern on the optical record medium 11. That is the visibility level of the test pattern written as seen by a human eye is a strong function of the power needed by the beam of light 260 to record the pattern on the optical record medium 11. When a pattern is recorded using this reference power value of the beam of light 260, it results in good visible labels.

In a fourth embodiment of the method according to the invention, the predetermined criterion for obtaining the reference power value is based on manual inspection of the gray level of the test pattern written on label side of the LightScribe disc. An image having a wide range of gray levels will have high contrast. A qualitative measure of the contrast is the standard deviation of the gray level of an image. Here, the manual inspection of the test pattern written on the optical record medium 11 is carried out by comparing the gray level of the test pattern written on the optical record medium 11 with a target gray level value available on a sheet of paper. FIG. 7 represents the relationship of the visibility of gray level of the test pattern written with respect to the power of the beam of light 260 used for recording the test pattern. The light power level of the beam of light 260 increases from point P to P¹ along the horizontal axis which results in recording the selected test pattern at various power levels P, . . . P¹ of the beam of light 260. The variation of this power level could even be decreasing from a high power value P¹ to P of the beam of light 260 for recording the test pattern. The vertical axis gives an indication of the visibility V, . . . V¹ of the gray level of the test pattern written at a particular power level of the beam of light 260. The test pattern written with a power level P, is read back and displayed on a display unit 72. This displayed test pattern on the display unit 72 is evaluated for gray level by a human eye. The human eye looks at the gray level of the written test pattern displayed on the display unit 72 and compares it with the gray level of the test pattern available on the sheet of paper 74. The human eye checks whether the gray level displayed on the display unit 72 is the same as the gray level on the sheet of paper 74. The power range 701 that gives close match of the gray level of the pattern displayed as compared with the gray level on a sheet of paper determines the reference power value of the beam of light 260 used for recording the test pattern. Using the power of beam of light 260 corresponding to the point where the gray level of the pattern written matches compared with the gray level on a sheet of paper 74 is important for ensuring precise recording of the pattern on the optical record medium 11. The power level of the beam of light 260 at which the visibility of the gray level of the test pattern written matches with the gray level on a sheet of paper 74 determines this reference power value.

In further embodiments, the various storage mechanisms that can be used to store the reference power value and the embodiments of the apparatus that can be used for recording visible labels are described.

In a fifth embodiment of the method of the invention and a second embodiment of the apparatus as shown in FIG. 8, the storage device used to store the reference power value obtained using the predetermined criterion as described in the previous embodiments is an Electrically Erasable Programmable Read Only Memory 243 of the apparatus 210 used for reading and writing to an optical record medium 11. The light beam power controller 250 makes use of this reference power value stored in EEPROM for controlling the intensity of the beam of light 260 generated by the light source 240 for writing labels. Further, since EEPROM is a non volatile memory, the reference power value can be retained even when the apparatus for reading and/or writing an optical record medium is switched off and hence can be used for subsequent labeling operation.

In a sixth embodiment of the method of the invention and a third embodiment of the apparatus as shown in FIG. 9, the storage device used to store the reference power value obtained using the predetermined criterion as described in the previous embodiments is a database 244. The apparatus 210 used for reading and writing on an optical record medium 11 is connected over the network or Internet 252 to this database 244. The apparatus 210 communicates with the database 244 over the network 252 and gets the reference power value from the database 244. This reference power value obtained from the database 244 is used by the light beam power controller 250 to control the intensity of the beam of light 260 for writing labels. This database can be accessed by a number of users or by the same user and hence the reference power value can be used for visible label recording.

In a seventh embodiment of the method of the invention and a fourth embodiment of the apparatus as shown in FIG. 10, the storage device used to store the reference power value using the predetermined criterion as described in the previous embodiments is a power meter 262. The apparatus 210 used for reading and writing on an optical record medium 11 is connected over the network or Internet 252 to a power meter 262. The apparatus 210 communicates with the power meter 262 over the network 252 and gets the reference power value from the power meter 262. This reference power value obtained from the power meter 262 is used by the light beam power controller 250 to control the intensity of the beam of light 260 for writing labels. Alternatively, the power meter 262 can be housed within the apparatus 210 used for reading and writing labels on the optical record medium 11 instead of being connected over the network 252. Since the reference power is stored in a power meter, subsequent calibrations can be carried out by using the power meter rather than using an optical record medium.

Further, the light beam power controller 250 of the apparatus 210 uses the calibrated power value that is stored in the storage device to control the intensity of the beam of light 260 for recording labels on the optical record medium. The calibrated reference power value stored will give the power ranges over which acceptable writing can be performed so as to result in good labels.

In the foregoing application, the invention has been described with reference to specific embodiments thereof. It will however be evident that various modifications and changes may be made without departing from the broader spirit and scope of the invention as set forth in the appended claims. The figures and drawings are accordingly, to be regarded for illustrative purposes rather than being used in the restrictive sense.

1-19. (canceled)

20. A method of calibrating power for writing a visible label on the label side (13) of an optical record medium comprising the steps of
recording patterns on the data side of an optical record medium using a beam of light (260), the patterns being recorded with different power of the beam of light (260),
reading back the patterns recorded on the data side of the optical record medium,
obtaining a reference power value from the patterns read back using a predetermined criterion,
using the reference power value obtained to calibrate the power for writing the visible label on the label side (13) of the optical record medium (11).

21. A method as claimed in claim 20 wherein the optical record medium is a phase change optical record medium.

22. A method as claimed in claim 21 wherein the predetermined criterion is based on a modulation depth of the patterns recorded.

23. A method as claimed in claim 22 wherein the predetermined criterion is based on a certain change in the modulation depth of the patterns recorded relative to the power of the beam of light used for recording the patterns.

24. A method as claimed in claim 23 wherein the predetermined criterion is based on modulation depth equal to the modulation depth of the pattern written.

25. A method as claimed in claim 21 wherein the predetermined criterion is based on evaluating the visibility of the patterns recorded.

26. A method as claimed in claim 25 wherein the visibility of the patterns recorded is evaluated based on a threshold level, the threshold level being the power at which a particular pattern recorded becomes visible in the read out signal.

27. A method as claimed in claim 20 wherein the reference power value obtained is stored in an Electrically Erasable Programmable Read Only Memory (243) of the apparatus for writing visible labels on the optical record medium.

28. A method as claimed in claim 20 wherein the reference power value obtained is stored in a database (244) which can be accessed over a network (252).

29. A method as claimed in claim 20 wherein the reference power value obtained is stored in a power meter (262) of the apparatus for writing visible labels on the optical record medium.

30. A method of recording a visible label on a optical record medium using the method of calibrating power as claimed in claim 20 wherein the power calibrated is used to control the intensity of the beam of light (260) so as to record the visible label on the optical record medium (11).

31. An apparatus for writing a visible label on the label side (13) of an optical record medium comprising
a light source (240) for recording patterns on the data side of an optical record medium (11),
a read head (230) for reading back the patterns recorded,
an analyser (252) for analysing the patterns read back using a predetermined criterion,
means for obtaining a reference power value,
storage means (242) for storing the reference power value obtained,
a power controller (250) for controlling the intensity of the light source using the reference power value, when recording the visible label on the label side (13) of the optical record medium (11).

32. An apparatus as claimed in claim 31 wherein the apparatus further comprises an Electrically Erasable Programmable Read Only Memory (243).

33. An apparatus as claimed in claim 31 wherein the apparatus further comprises a database (252).

34. An apparatus as claimed in claim 31 wherein the apparatus further comprises a power meter (262).
